(19) United States
(12) Patent Application Publication
(10) Pub. No.: US 2006/0056918 A1
(43) Pub. Date: Mar. 16, 2006

(54) Riser system connecting two fixed underwater installations to a floating surface unit

(76) Inventor: Ange Luppi, Nimes (FR)

Correspondence Address: OSTROLENK FABER GERB & SOFFEN, 1180 AVENUE OF THE AMERICAS, NEW YORK, NY, 100368403, US

(21) Appl. No.: 10/515,197

(22) PCT Filed: May 12, 2003
(86) PCT No.: PCT/FR03/01437

§ 371 Date: Nov. 19, 2004

(30) Foreign Application Priority Data
May 22, 2002 (FR) 02/06231

(51) Int. Cl. F16L 1/12; E21B 17/01

(52) U.S. Cl. 405/169; 405/195.1; 166/350

(57) ABSTRACT

A riser system for connecting two subsea installations to a floating surface unit. In a preferred embodiment, each of the two subsea installations comprises a flexible pipe arranged in a first catenary and extending between the surface unit and a submerged buoy. Each buoy is anchored to the seabed by a tether device comprising at least two taut tethers. A riser arranged in a second catenary extends between the buoy and being fixed at the seabed. At least one weighted return line in a third catenary connects the two buoys.

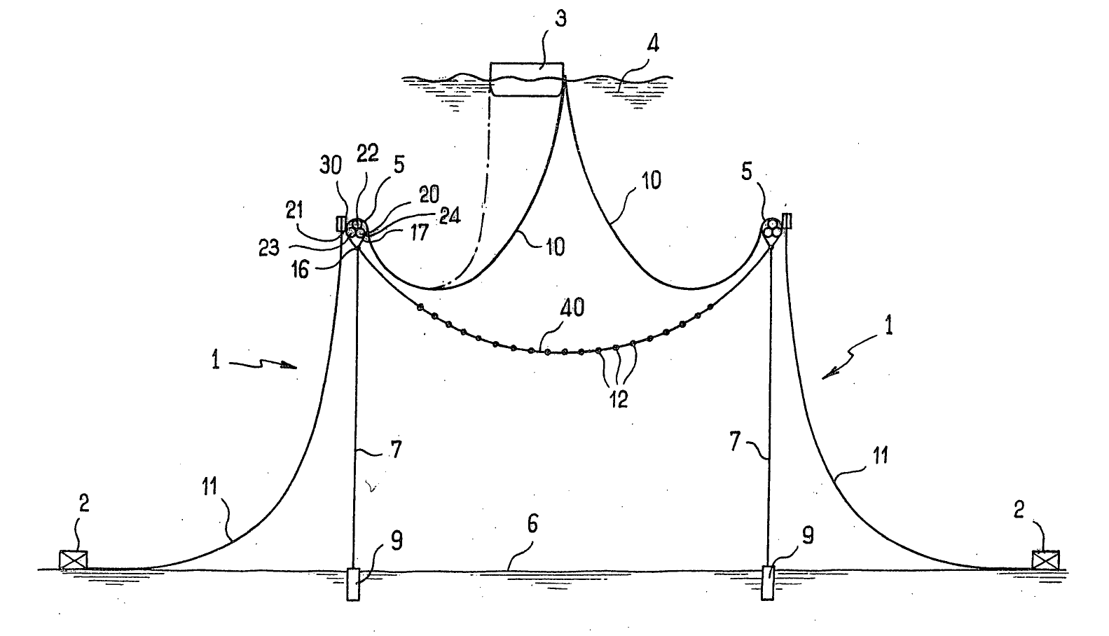

The present invention relates to a riser tower system intended to connect at least two fixed subsea installations such as a well head or a manifold to a floating surface unit such as a platform or a ship of the FPSO (Floating Platform Storage and Offloading) type.

Offshore operation of an oil field is increasingly complicated as the water depth increases, which depth these days may be as much as several thousands of metres. The transfer of product from the fixed installation, situated on the seabed and usually consisting of a well head, to the floating surface installation or unit, poses a certain number of difficulties. The most commonly used transfer systems are those known as riser tower systems which comprise pipes through which various products to be transported between the seabed and the surface flow, these products being, for example, oil, gases, water, etc. Other pipes may also be used, particularly fluid-injection, charging or electrical and/or hydraulic control lines.

In drilling for oil, particularly when the deposits are very deep down, the areas of turbulence which lie between 50 and 300 m below the surface of the water may have effects not only on the surface unit or installation which may move as a result of the swell and of other phenomena such as pitching, rolling, etc., but may also have an influence on the riser tower system which experiences forces due to the waves, to the wind and to marine currents.

As a result, riser tower systems are designed to withstand these stresses the magnitudes of which may vary.

Various types of riser tower system have been proposed, these are described for example in U.S. Pat. Nos. 3,111,692, 3,677,302, 4,031,919, 4,188,156, 4,182,584, 4,388,022, 4,400,109 and 4,423,984.

The main disadvantages with these systems lie in the fact that it is necessary to use buoys of great buoyancy of at least 2000 tonnes; furthermore, when this buoyancy is distributed over the entirety of the riser, the elements of the buoy having to withstand significant pressures. Another disadvantage is that these systems are manufactured on land and have then to be brought out to and installed on the site, all of these operations being tricky and expensive. In addition, it is very difficult to anchor the ends of the rigid sections to the seabed without using divers or very sophisticated equipment such as ROVs (Remote Operated Vehicles), and this introduces not insignificant costs into the placement and monitoring while the field is being exploited.

U.S. Pat. No. 5,639,187 describes a system which combines rigid pipes and flexible pipes to establish the fluid communication between the fixed subsea installation and the surface unit, the system comprising a submerged buoy which is anchored to the seabed by means of four taut tethers, each of the tethers being attached to the ends of the buoy and to a corner of a kind of rectangle formed on the seabed, so as to minimize the rotation of the buoy that could be brought about by horizontal forces and by the weight of the pipes running between the buoy and the seabed. In fact, the system is of the tension leg type, these having to withstand vertical loadings of at least 1500 tonnes and even more in order, especially during installation, to react the buoyancy of the buoy which has to be greater than the weight of the pipes, of which there are a great many in such an application. The submerged buoy has also to have a reserve of buoyancy so as to give the entire system the stiffness it needs to limit its lateral movements. What happens is that the lateral movements of the buoy are undesirable because they bend the rigid pipes to bend radii such that these pipes may experience plastic deformation and thus cause the beginning of crushing by ovalization at the sag bend. The sag bend lies over the touchdown point (or TDP for short) which is where the pipes touchdown onto the seabed.

The Applicant Company has already proposed, in the French patent application No. 02 05 378 of 29 Apr. 2002, a riser tower system which is better suited to the movements of the surface unit, simple to produce and to install and less expensive than the systems of the prior art, for comparable operating conditions. According to that application which is not yet published at the time of the present application, it is a riser tower system intended to connect a fixed subsea installation to a surface unit, of the type comprising at least one flexible pipe arranged in a catenary and extending between the surface installation and a submerged buoy, at least one riser arranged in a catenary between the said buoy and the seabed, the said buoy being anchored to the seabed by a tether device comprising at least two taut tethers, and which is characterized in that it comprises at least two moorings in a catenary and on which there are provided return means which exert on the said buoy a return force that depends on the lateral movement of the said buoy. When the submerged buoy moves laterally, it is automatically returned to its initial position or position of equilibrium by the return means the force of which is variable, that is to say that they develop a return force which is dependent upon the amplitude of the lateral movement of the buoy.

The present invention aims at an alternative solution to the preceding solution, when the issue is one of connecting at least two fixed subsea installations to a floating surface installation. The present invention proposes a riser tower system intended to connect two fixed subsea installations to a floating surface unit, of the type comprising at least one flexible pipe arranged in a catenary and extending between the surface installation and at least one submerged buoy, at least one riser arranged in a catenary between the said buoy and the seabed, the said buoy being anchored to the seabed by a tether device comprising at least two taut tethers, characterized in that it comprises two submerged buoys each one associated with at least one riser connected to a respective one of the two fixed subsea installations and a flexible pipe in a catenary, and at least one return line in a catenary connecting the two buoys. This catenary return line is heavy and/or weighted at least over part of it so that, through its own or its added weight, it can exert the necessary lateral return force on the buoys. When one of the two buoys moves laterally, the line begins to go taut, increasing the horizontal component (return component) of the force exerted on the buoy. This action of the return or retaining line, which is exerted first of all, may be supplemented by the reaction of the second buoy and of the risers it bears, which reaction also contributes to returning the first buoy to its initial position later. It is possible to provide more than one return line, such as two lines for example, connecting the respective ends of the buoys.

The return line is advantageously arranged between the buoys and, as a preference, does not rest on the seabed. However, the catenary may be any shape and may go so far as to rest on the seabed without departing from the scope of the invention.

Advantageously, the return line is, like the tethers themselves, connected to each buoy by a flange or mooring bridle arranged under the buoy and intended to prevent or at the very least limit the rotation of the buoy.

The flexible pipes (“jumpers”) connecting each buoy to the floating installation can be located on a same side of said floating installation or on both sides, according to the needs and the wished configuration.

Other advantages and features will become apparent from reading the description of one embodiment of the present invention and from the single appended drawing depicting a schematic view in elevation of the riser tower system according to one embodiment of the invention.

The riser system 1 is intended to connect two fixed subsea installations 2, consisting for example of a well head, a manifold or some other collector and delivering a product from an oil deposit or the like, to a floating surface unit or installation 3 such as a platform or an FPSO, the distance separating the surface 3 and subsea 2 installations being possibly as much as several thousands of metres. At a certain distance from the surface 4 of the water, and generally beyond the area of turbulence of the stretch of water concerned, are two submerged buoys 5 each of which is anchored to the seabed 6 by at least two tethers 7, respectively, which are stretched between the buoy 5 and a deadweight 9 or other anchoring means (suction pile). The two or three lines 7 of one and the same buoy 5 are in roughly the same vertical plane perpendicular to the plane of the drawing; this is why just one line is visible in the drawing for each buoy 5.

One or several flexible pipes 10 running in a catenary between the surface unit 3 and each buoy 5 are connected to one or several risers 11 extending in a catenary between each buoy 5 and the associated fixed subsea installation 2 so that fluid communication is established between the said installations 2 and 3. The risers 11 running in a catenary from the buoys 5 to the seabed may be of any type such as rigid pipes commonly known as SCRs (Steel Catenary Risers), single-walled or pipe in pipe and even flexible pipes or hybrid pipes having at least one flexible part and one rigid part.

The dual riser tower system comprises at least one return or retaining line 40 arranged in a catenary between the two buoys 5. This catenary line 40 may be a heavy chain or a line which is weighted by ballast weights 12. The weights of the line or of the ballast weights 12 constitutes return means for the buoy 5, which diverts laterally (in the direction transversal to the tethers 7 of one and the same buoy), the return force being dependent chiefly upon the lateral movement that the said buoy 5 might have and which may be caused by a strong swell, marine currents and more generally by movements of the surface unit 3. The ballast weights 12 may consist of weights, balls, chains or clump-weight.

Each taut tether 7 is attached to a corner 16 of a flange or mooring bridle 17 fixed to the buoy 5 at one end thereof, and which is also intended to prevent or greatly limit the rotation of the buoy. The points of attachment of the tethers 7 to the flanges 17 are preferably roughly in the midplane passing through the longitudinal axis of the buoy 5, perpendicular to the plane of the figure.

The return line 40 may be connected to an end 20 of the buoy 5 which is the opposite end to the other lateral end 21 to which the riser or risers 11 is or are connected. It is preferably connected, as depicted, to the corner 16 of the flange 17 so that the points of attachment of the return line 40 lie more or less in the midplane in which the points of attachment of the moorings 7 to the buoy 5 are situated.

In a preferred embodiment of the invention, the buoy 5 has variable buoyancy and comprises several parts, for example three parts 22 to 24 each consisting of a hollow cylinder. Such a structure of the buoy 5 makes it possible to avoid having to develop very high forces at the buoy 5, which forces are dependent in particular on the number and weight of risers to be provided between the seabed 6 and the said buoy 5. Indeed, by virtue of this compartmentalization of the buoy 5, each cylinder 22 to 24 constitutes a compartment which can be partially or completely emptied as additional risers are added. Thus, in a first phase, the compartments are filled with an appropriate fluid such as water. Then, once the first riser has been fitted, part of a compartment is emptied and filled with gas, the amount emptied being a function of the weight of the riser or risers fitted. This procedure then continues sequentially and in the same way for the other risers.

According to the described embodiment of the invention, the risers 11 are connected to the associated flexible pipes 10 by end fitting connections in a way known per se. These risers 11 are supported by the buoy 5 by a connection and suspension receptacle device shown schematically in the figure and referenced 30, in which their terminal end fitting is housed. It can be noted that this device may comprise damping means intended to allow the risers a certain angular excursion with respect to the buoy 5 at their connection.

1.-7. (canceled)

8. A riser system for connecting two spaced apart fixed subsea installations to a floating surface unit comprising:
a first and a second submerged buoy subsea and spaced apart;
at least one respective flexible pipe arranged in a first catenary and extending between the surface unit and each of the first and second submerged buoys, each of the buoys being anchored to the seabed by a respective taut tether device;
at least one respective riser arranged in a second catenary between each of the buoys and the seabed where each riser is connected to a respective one of the two fixed subsea installations; and
at least one return line in a third catenary connects to the two buoys.

9. The riser system according to claim 8, wherein the return line is at least one of itself heavy and weighted over at least part of its length.

10. The riser system according to claim 9, further comprising a respective bridle at the buoy, the return line is connected to each buoy by the respective bridle, such that the bridle is adapted to prevent the buoy from rotating.

11. The riser system according to claim 9, wherein the taut tether device of each buoy lies roughly in a mid-plane passing through a longitudinal axis of the buoy and perpendicular to a plane containing the return line.

12. The riser system according to claim 8, wherein each buoy is of variable buoyancy.

13. The riser system according to claim 12, wherein each buoy is comprised of several parts each separately variable in buoyancy.

14. The riser system according to claim 8, wherein each buoy has first and second opposite ends; and the return line is connected to the first end of each buoy, and the respective riser is connected to the opposite second end of each buoy.

15. The riser system according to claim 11, wherein the return line is connected to each of the submerged buoys at a point lying roughly on the midplane passing through the longitudinal axis of the buoy and perpendicular to a plane containing the return line.

16. The riser system according to claim 8, wherein the return line is connected to each of the submerged buoys at a point lying roughly on a midplane passing through the longitudinal axis of the buoy and perpendicular to a plane containing the return line.

17. The riser system according to claim 8, wherein each tether device comprises at least two taut tethers.

18. The riser system according to claim 17, wherein the at least two tethers of each buoy lie roughly in a mid-plane passing through a longitudinal axis of the buoy and perpendicular to a plane containing the return line.
